(19) United States
(12) Patent Application Publication
(10) Pub. No.: US 2001/0022196 A1
(43) Pub. Date: Sep. 20, 2001

(54) Multiway valve with a removable exhaust wall

(75) Inventor: Peter Fagerstrom, Huddinge (SE)

Correspondence Address: Thomas C. Pontani, Esq., Cohen, Pontani, Lieberman & Pavane, Suite 1210, 551 Fifth Avenue, New York, NY, 10176, US

(73) Assignee: AB Rexroth Mecman

(21) Appl. No.: 09/796,048

(22) Filed: Feb. 28, 2001

(30) Foreign Application Priority Data
Feb. 29, 2000 (DE) 100 10 877.6

(51) Int. Cl. F16K 11/20

(52) U.S. Cl. 137/596.18

(57) ABSTRACT

A multiway valve for controlling the flow of a pressure medium from at least one delivery port to at least one exhaust port or supply port includes a valve housing with a substantially cylindrical axial bore with a plurality of annular steps forming inner chambers for connecting the ports. The multiway valve further includes a spool arrangement for switching the flow of the pressure medium. The spool arrangement includes two valve spools arranged coaxially and in tandem in the axial bore. The two valve spools are independently axially slidable within the axial bore. Each valve spool is associated with at least one driving piston for axially shifting the valve spool in response to a control pressure. A common exhaust chamber is arranged next to the inner ends of the valve spools in the center of the axial bore to provide a connection to the at least one exhaust port. An exhaust wall is arranged between the inner ends of the valve spools in the exhaust chamber for dividing the chamber in two parts and directing a main exhaust stream from the each valve spool to the at least one exhaust port.

### BACKGROUND OF THE INVENTION

1. Field of the Invention

The present invention relates to a multiway valve for controlling the flow of a pressure medium. More particularly, the present invention relates to a multiway valve with a movable inner spool for switching the flow of a pressure medium between outer ports, the multiway valve including two 3/2-way valves integrated in a 5/2-way or 5/3 way valve housing.

2. Description of the Related Art

Multiway valves for controlling the flow of pressure medium are known from German reference DE 44 00 760 C2. The disclosed multiway valve comprises a valve housing with an axially extending bore extending therethrough having a plurality of steps forming inner chambers. Further, a valve spool arrangement is arranged therein which is longitudinally moveable by drive pistons in response to a control pressure to influence the supply of an actuating fluid to two delivery ports.

The valve spool arrangement includes two separate valve spools respectively associated with the two delivery ports. The two valve spools are arranged coaxial in tandem in the valve bore extending from one end to the other end of the valve bore. Each of the valve spools is independently longitudinally shiftable upon application of a suitable control pressure on a respective drive piston. In this way, two separate multiway valves are connected in a single multiway valve housing. Each of the two valve spools arranged in the common valve housing provide a respective 3/2-way valve function, with each valve spool having its own exhaust port associated with it. The two valve spools are preferably provided with a common supply port arranged proximate the inner ends of both the valve spools in the center of the axially extending bore.

This known multiway valve is designed such that the two valves may be exchanged with a conventional single piece valve spool to realize the function of a 5/2-way or a 5/3-way valve.

Furthermore, it is also known to arrange the ports of a multiway valve or the chambers inside the valve housing so that the central port is a common exhaust port (or chamber) for the two integrated 3/2-way valve functions. When a common exhaust port is used, the exhaust port is flanked on both axial sides by the delivery ports. The two supply ports surround the axial outer sides of the two delivery ports. Therefore, when a common exhaust valve it used, the exhaust air from one of the two 3/2 valves may affect the other 3/2 valve by generating an undesired output signal at the other 3/2 valve.

### SUMMARY OF THE INVENTION

The object of the present invention is to provide a multiway valve which provides a reliable separation of different integrated valves so that respective separate spools operate independently in a common housing.

The object is met according to the present invention by a multiway valve for controlling the flow of a pressure medium from a delivery port to one of an exhaust port and a supply port. The multiway valve includes a valve housing having an axial bore and a plurality of steps forming a plurality of inner chambers. The plural inner chambers are respectively connected to at least one delivery port, at least one exhaust port and at least one supply port. The multiway valve also includes a spool arrangement operatively arranged for switching a flow pressure medium between the at least one delivery port and one of the at least one exhaust port and the at least one supply port. The spool arrangement has two valve spools having mutually facing inner ends. The two valve spools are arranged coaxially and in tandem with respect to each other in said axial bore such that each of the two valve spools are independently slidable within said axial bore. At least one drive piston corresponds to each of the two valve spools. The at least one drive piston is axially movable in response to a control pressure for axially shifting a corresponding one of the two valve spools. One of the plural inner chambers is a common exhaust chamber arranged proximate the inner ends of the two valve spools at a central area of said axial bore and comprises a connection for the at least one exhaust port. A removable exhaust wall is operatively arranged between the inner ends of the two valve spools for directing an exhaust stream from each of the two valve spools to the at least one exhaust port.

Accordingly, the present invention includes a multiway valve with a common housing and two separate spools with an exhaust chamber arranged proximate the inner ends of both valve spools in the center of the axial bore of the common housing to provide a connection of each valve with the at least one exhaust port. A removable exhaust wall is arranged in the exhaust chamber for dividing the exhaust chamber into two parts. The exhaust wall is arranged in the exhaust chamber between the inner ends of both valve spools to direct the exhaust air stream from each valve spool directly into the at least one exhaust port.

The present invention avoids an undesired output signal using a simple solution for reliable separation of the two integrated 3/2 valves. Each of the valve spools does not influence the other of the valve spools because the main exhaust stream enters directly into the exhaust port. The exhaust wall forces the exhaust air into the exhaust port instead of against an open output on the other valve spool. The exhaust wall is not required to be air tight. Rather its main purpose is only to guide the main exhaust stream toward the desired direction. The removable exhaust wall may be shaped like a thin disk.

The removable exhaust wall may be disposed in a groove arranged on the inner surface of the exhaust chamber. The groove provides a simple arrangement for fixing the exhaust wall inside the exhaust port. The exhaust wall may be removable from the groove through the exhaust port or any other suitable manner.

In a further embodiment, the common exhaust chamber is connected to the exhaust port via two separate exhaust channels. It is also possible to provide two exhaust ports for each exhaust channel. Both channels are arranged in a respective part of the exhaust chamber to support the guide functions of the exhaust wall.

In another embodiment of the present invention, the two valve spools of the 3/2-way valves are interchangeable with a spool arrangement having a single piece valve spool to provide a 5/2-way or a 5/3-way valve. The installation of the single piece valve spools requires the removal of the exhaust wall from the exhaust chamber. Therefore, it is possible to change the valve function by changing the valve spool arrangement.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters denote similar elements throughout the several views:

FIG. 1 is an axial sectional view of a multiway valve according to the present invention with two 3/2-way valve function produced by two independently operable valve spools in one common valve housing; and

FIG. 2 is an axial sectional view of a multiway valve according to another embodiment of the present invention with one single piece valve spool arranged for providing a 5/2-way valve function.

### DETAILED DESCRIPTION OF THE PRESENTLY PREFERRED EMBODIMENTS

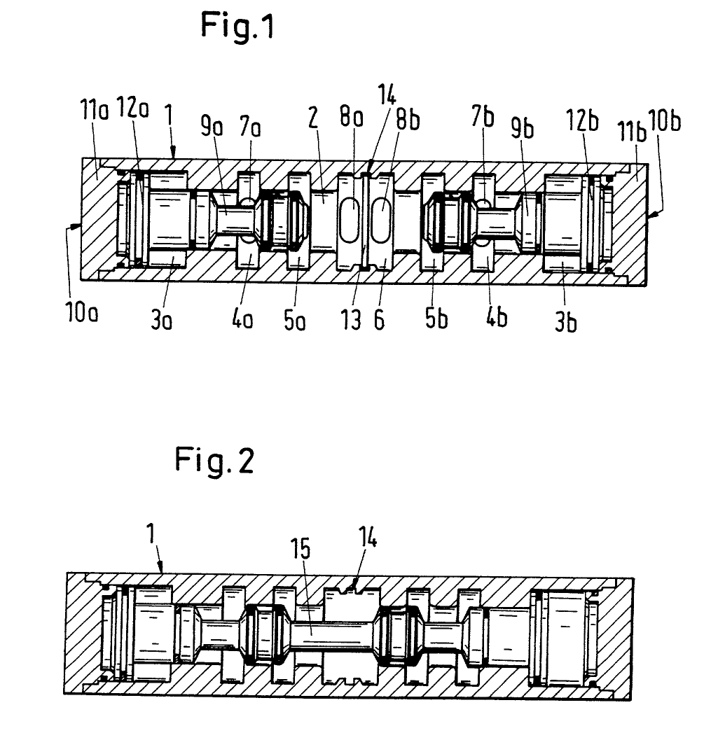

A pneumatic multiway valve is shown in FIG. 1 according to an embodiment of the present invention with an oblong valve housing 1. The valve housing has an axial bore 2 with a plurality of annular steps forming inner chambers 3a, 3b, 4a, 4b, 5a, 5b, and 6. The inner chambers 4a, 4b are connected with corresponding outer supply ports 7a, 7b. The inner chambers 5a, 5b are connected with outer delivery ports (not shown). The central inner chamber 6 is connected to two parallel outer exhaust ports 8a and 8b. The outer exhaust ports may also comprise two channels 8a and 8b of a common exhaust port. The outer supply ports 7a, 7b, the outer delivery ports, and the outer exhaust ports are preferably arranged in one plane on the valve housing 1 so that the valve housing 1 may be mounted on a fluid manifold element. For switching the flow of pressurized air between the ports, two valve spools 9a, 9b are axially guidably arranged in the axial bore 2. The valve spools 9a, 9b are arranged coaxially and in tandem so that they are independently axially slidable within the axial bore 2. Accordingly, the above-described arrangement provide two 3/2-way valves within the valve housing 1.

The valve housing 1 has two front sides 10a, 10b including respective caps 11a, 11b for sealing the axial bore. The inner chambers 3a, 3b arranged directly against the respective caps 11a, 11b comprise control chambers. Each control chamber 3a, 3b is connectable to a control fluid supply under a control pressure to selectively shift the valve spools 9a, 9b in the axial direction via respective drive pistons 12a, 12b for switching the fluid flow.

A common exhaust chamber 6 is disposed proximate the inner ends of both of the valve spools 9a, 9b. A removable exhaust wall 13 is arranged in the common exhaust chamber 6 between the two valve spools 9a, 9b. The exhaust wall 13 divides the exhaust chamber into two parts to direct the exhaust air stream from each of the valve spools 9a, 9b directly to the exhaust ports (channels) 8a, 8b, thereby preventing the exhaust air stream of one of the valve spools 9a, 9b from affecting the other of the valve spools 9a, 9b. The disk-shaped wall is 13 is arranged in a groove molded into an inner surface of the common exhaust chamber 6.

FIG. 2 shows the same valve housing 1 as in FIG. 1. However, the two valve spools have been replaced by a spool arrangement including a single piece valve spool 15 to provide a 5/2-way valve. The single piece valve spool 15 may alternatively be arranged for providing a 5/3-way valve. As shown in FIG. 2, the removable exhaust wall 13 of FIG. 1 must be removed from the groove 14 to insert the single piece valve spool 15.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

I claim:

1. A multiway valve for controlling the flow of a pressure medium from a delivery port to one of an exhaust port and a supply port, said multiway valve comprising:
a valve housing having an axial bore and a plurality of steps forming a plurality of inner chambers, wherein said plural inner chambers are respectively connected to at least one delivery port, at least one exhaust port and at least one supply port;
a spool arrangement operatively arranged for switching a flow pressure medium between said at least one delivery port and one of said at least one exhaust port and said at least one supply port, wherein said spool arrangement comprises two valve spools having mutually facing inner ends, said two valve spools being arranged coaxially and in tandem in said axial bore, each of said two valve spools being independently slidable within said axial bore;
at least one drive piston corresponding to each of said two valve spools, wherein said at least one drive piston is axially movable in response to a control pressure for axially shifting a corresponding one of said two valve spools,
one of said plural inner chambers comprising a common exhaust chamber arranged proximate said inner ends of said two valve spools at a central area of said axial bore and comprising a connection for said at least one exhaust port; and
a removable exhaust wall operatively arranged between said inner ends of said two valve spools for directing an exhaust stream from each of said two valve spools to said at least one exhaust port.

2. The multiway valve of claim 1, wherein said removable exhaust wall is disk-shaped.

3. The multiway valve of claim 1, further comprising a groove molded into an inner surface of the common exhaust chamber, wherein said removable exhaust wall is disposed in said groove.

4. The multiway valve of claim 1, further comprising separate parallel exhaust channels respectively corresponding to said two valve spools, wherein said common exhaust chamber is connected to said at least one exhaust port via said separate parallel exhaust channels.

5. The multiway valve of claim 3, wherein said removable exhaust wall is removable from said groove via said at least one exhaust port.

6. The multiway valve of claim 1, wherein said two valve spools are interchangeable with a single piece valve spool when said exhaust wall is removed.

7. The multiway valve of claim 6, wherein said single piece valve spool is operatively arranged for providing one of a 5/2-way and 5/3-way valve.

8. The multiway valve of claim 1, wherein said at least one delivery port, said at least one exhaust port, and said at least one supply port are arranged in one plane on said valve housing so that said valve housing is mountable on a fluid manifold element.
